(19) United States
(12) Patent Application Publication
(10) Pub. No.: US 2008/0301404 A1
(43) Pub. Date: Dec. 4, 2008

(54) METHOD FOR CONTROLLING AN ELECTRONIC CIRCUIT AND CONTROLLING CIRCUIT

(75) Inventors: ANGEL JOERN, Bochum (DE); Christian Duerdodt, Bochum (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/756,275

(22) Filed: May 31, 2007

(51) Int. Cl. G06F 15/00

(52) U.S. Cl. 712/27; 712/E09.001

(57) ABSTRACT

A method for controlling an electronic circuit including selecting at least one pre-stored generating rule from a plurality of pre-stored generating rules according to which a message which is to be transmitted to the electronic circuit for carrying out a controlling function to control the electronic circuit is to be generated, and generating the message according to the at least one selected generating rule.

### BACKGROUND

The present invention relates generally to a method for controlling an electronic circuit and controlling circuit.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a mobile radio device according to an embodiment of the invention;

FIG. 2 shows a communication arrangement according to an embodiment of the invention;

FIG. 3 shows a data telegram according to an embodiment of the invention;

FIG. 4 shows a flow diagram according to an embodiment of the invention;

FIG. 5 shows a data flow diagram according to an embodiment of the invention;

FIG. 6 shows a flow diagram according to an embodiment of the invention; and

FIG. 7 shows a controlling circuit according to an embodiment of the invention.

### DESCRIPTION

According to one embodiment of the invention a method for controlling an electronic circuit is provided including selecting at least one pre-stored generating rule from a plurality of pre-stored generating rules according to which a message which is to be transmitted to the electronic circuit for carrying out a controlling function is to be generated to control the electronic circuit, and generating the message according to the at least one selected generating rule.

According to another embodiment of the invention a controlling circuit and a computer program product according to the method for controlling an electronic circuit are provided.

Illustratively, a controlling messages for controlling the electronic circuit is generated according to at least one pre-stored generating rule. A plurality of generating rules may be stored, for example for various designs of the electronic circuit and for a plurality of controlling functions. Thus, for example, instead of the contents of the message, a generating rule for generating the contents is stored. The generating rule may for example specify at which positions bits values should be written into the message and may specify positions in a memory where bit values are located that are to be written into the memory. The generating rule may be stored in a predetermined fixed format or may be a command written in a programming language, such as a simple script language, that is for example parsed and interpreted and according to which the message is generated.

The message may for example include a data word and the at least one pre-stored generating rule may specify first positions of a memory at which bits are read from the memory and second positions in the data word at which the bits read are written into the data word. For example, the at least one rule further specifies at least one combination operation according to which the bits read are combined and the method further includes writing the combined bits into the data word.

The pre-stored generating rule is for example selected based on the type of the electronic circuit. The pre-stored generating rule may also be selected based on the type of the controlling function.

In one embodiment, the plurality of pre-stored generating rules include a generating rule for a plurality of pairs of a type of the electronic circuit and a type of the controlling function.

The electronic circuit is for example controlled by another electronic circuit and the electronic circuit and the other electronic circuit are for example part of the same computer. The computer may for example be a personal computer or a workstation but as well a communication device, such as a cell phone, or a controlling system of a vehicle.

In one embodiment, the electronic circuit and the other electronic circuit are located in the same housing.

The electronic circuit and the other electronic circuit are for example coupled by an interface and the message is for example transmitted via the interface. The interface may be a parallel or a serial interface. For example, the interface is a (computer) bus.

In one embodiment, the electronic circuit is an electronic circuit of a mobile communication device. The electronic circuit is for example a front-end component of the mobile communication device. For example the electronic circuit is controlled by another electronic circuit of the mobile communication device, e.g. a high frequency integrated circuit.

The controlling function is for example switching the electronic circuit on or off, switching the electronic component into one of a plurality of modes, or activating or deactivating a function of the electronic circuit, or the setting of physical parameters for the operation of the electronic circuit, for example the setting of a frequency range according to which the electronic component should be operating.

A memory used in the embodiments of the invention may be a volatile memory, for example a DRAM (Dynamic Random Access Memory) or a non-volatile memory, for example a PROM (Programmable Read Only Memory), an EPROM (Erasable ROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

A circuit can be a hardware circuit, e.g. an integrated circuit, designed for the respective functionality or also a programmable unit, such as a processor, programmed for the respective functionality.

In an electronic system, like for example a mobile radio device, it may be the case that there are two or more electronic components which need to communicate using a digital data interface. For example, two electronic components of an electronic system exchange data telegrams via a digital data interface which include control information such as address information or read/write indicators and useful data. For instance, one of two components controls the other component by sending data telegrams and receives information from the other component, for example sensor measurement data.

It may be the case that, especially when the two electronic components are produced by two different manufacturers, when an electronic component which should control another electronic component is manufactured, the contents of the data telegrams which need to be sent to the controlled component for controlling, for example for initiating certain functions of the controlled component, are not yet defined at time of manufacture. In this case, it is necessary that the controlling electronic component can be configured according to various designs of the controlled component after the controlling electronic component has been manufactured.

The configuration of the controlling electronic component can be carried out after having manufactured the controlling electronic component when the design of the controlled electronic component has become clear and, for example, the contents of the data telegrams for initiating certain functions of the controlled component have been defined. This configuration may for example be carried out by storing the necessary information, such as contents of data telegrams, in the controlling electronic component itself (for example using electrically programmable fuses) or in an external memory (such as an EPROM or an EEPROM).

Alternatively, the controlling component may be configured during run time by another electronic component. For example, for having full flexibility, e.g. for having the opportunity to reconfigure the controlling component even after the electronic system including the controlling component and the controlled component has been put in operation, it is a possibility to let another electronic component provide the contents of data telegrams necessary for initiating desired functions of the controlled component during run time. However, in the case that every data telegram for a high number of possible designs of the controlled component which may be necessary during run time is stored in a memory, memory consumption may be very high.

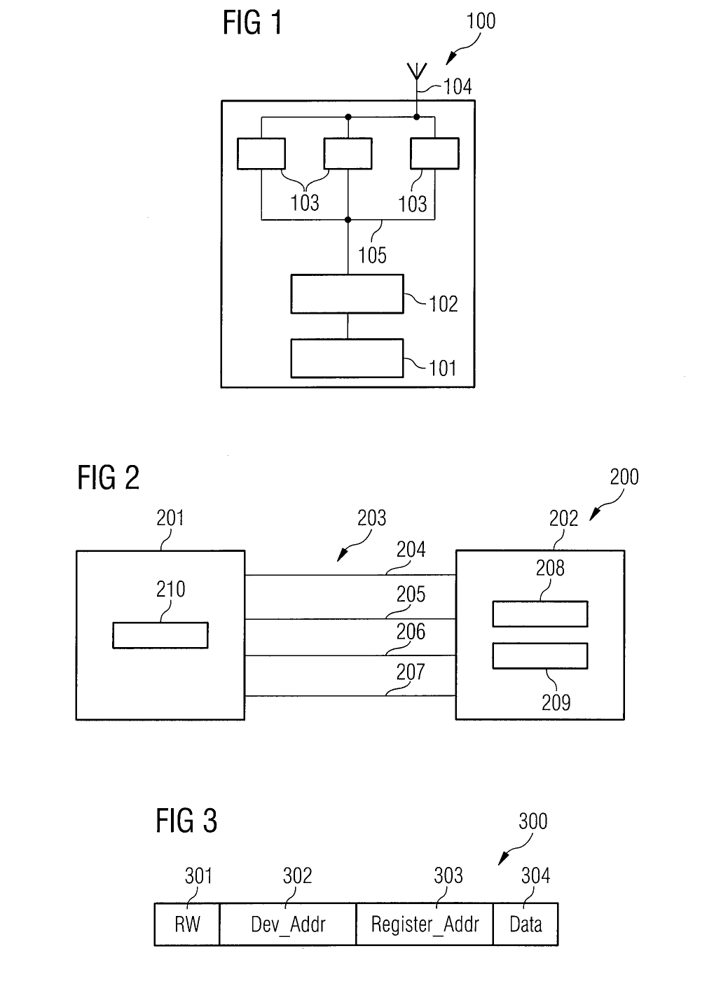

FIG. 1 shows a mobile radio device 100 according to an embodiment of the invention.

The mobile radio device 100 includes a baseband IC (integrated circuit) 101, a high frequency IC (HFIC) 102, a plurality of front-end components (also denoted as peripheral devices) 103 and an antenna 104. The baseband IC 101 controls the high frequency IC 102. The high frequency IC 102 itself controls the front-end components 103 via a serial interface (denoted as SPI: serial peripheral interface) 105 which, in this example, is implemented as a bus. In this embodiment, the interface 105 is a serial interface but in other embodiments it may also be a parallel interface, for example a bus using a plurality of parallel bit lines. The high frequency IC 102 controls the interface 105, i.e. is the (bus) master of the interface 105.

A front-end component 103 is for example a low noise amplifier (LNA), a power amplifier (PA), or a filter module. The front-end components 103 are connected between the high frequency IC 102 and the antenna 104. The connection of the high frequency IC 102 and a front-end component 103 via the interface 105 is explained in more detail with reference to FIG. 2.

FIG. 2 shows a communication arrangement 200 according to an embodiment of the invention.

The communication arrangement 200 includes a high frequency IC 201 and a front-end component 202 connected via an interface 203.

Only one front-end component 202 is shown but, as described with reference to FIG. 1, a plurality of front-end components 202 may be connected to the high frequency IC 201 in the same way.

In this example, the interface 203 includes a voltage line 204, a clock line 205, an enable line 206 and a data line 207. Via the voltage line 204, which is a unidirectional line, the high frequency IC 201 supplies the power for the interface 203. Using the clock line 205, which is also a unidirectional line, the high frequency IC 201 supplies the front-end component 202 with a clock signal for the interface 203. Via the enable line 206, the high frequency IC 201 may send an enable signal to the front-end component 202.

The data line 207 is bidirectional and may be used for exchanging data telegrams (messages) between the high frequency IC 201 and the front-end component 202. In this example, the data line 207 is a single bit line and the interface is a serial interface. However, it is also possible that there is a plurality of data lines 207 and data is sent in parallel on a plurality of bit lines.

The front-end component 202 includes one or more (in this example for simplicity only one) read register 208 from which the high frequency IC 201 may read data via the interface 203 as will be explained below. Further, the front-end component 202 may include one or more (in this example only one for simplicity) write registers 209 to which the high frequency IC 201 may write data as will also be explained below. In other embodiments, the front-end component 202 includes only one or more read registers and no write register or one or more write registers and no read register.

The high frequency IC 201 includes a memory 210, for example a plurality of HFIC registers.

The content of the write register 209 defines the operation of the front-end components 202. For example, one bit of the write register 209 may specify whether the front-end component 202 is to be switched on and another bit or a plurality of other bits may define a mode in which the front-end component 202 is to be operating.

For controlling the front-end component 202, the high frequency IC 201 sets the bits of the write register 209, i.e. writes data into the write register 209. This is done by sending a data telegram (message) via the data line 207. An example for such a data telegram is shown in FIG. 3.

FIG. 3 shows a data telegram 300 according to an embodiment of the invention.

The data telegram 300 includes a read/write bit 301, a plurality of device address bits (in this example three bits) 302, a plurality of register address bits (in this example five bits) 303 and a plurality of data bits (in this example 16 bits) 304.

In other embodiments the order of these data blocks (read/write bit 301, plurality of device address bits 302, plurality of register address bits 303, plurality of data bits 304) in the data telegram 300 may be different from the example given above. Further, the lengths of the data blocks may be different, e.g. there may be 32 data bits 304.

In the write case, i.e. in the case the high frequency IC 201 writes data into the write register 209, the read/write bit 301 is set to the value 0, and the data telegram 300 is sent from the high frequency IC 201 via the data line 207 bit by bit starting with the read/write bit 301 and continuing from left to right. For example, in each cycle of the clock signal provided on the clock line 205, a bit of the data telegram 300 is sent. The device address bits 302 specify the front-end component 202 such that it is possible that more than one front-end components are connected via the interface 203 to the high frequency IC 201. The register address bits 303 specify the write register 209 such that, if the front-end component includes more than one write register, the write registers may be addressed, and the data bits 304 are the bits which are written into the write register 209.

The data bits 304 are 16 bits in this example and the write register 209 is a 16 bit register. The write register 209 may also include more than 16 bits in other embodiments. In this case, a plurality of data telegrams may be used to write data to the write register 209.

In the read case, the read/write bit 301 is set to the value 1, the device address bits 302 and the register address bits 303 are sent and used by the high frequency IC 201 as in the write case, wherein in this case, the register address bits 303 specify the read register 208 (for the case that there are more than one read registers). However, in the read case, the data bits 304 are sent (as above starting with the read/write bit 301 from left to right) from the front-end component 202 to the high frequency IC 201 via the data line 207. In this case, the data bits 304 are the content of the read register 208. The transmission of the data bits 304 from the front-end component 202 to the high frequency IC 201 starts when the last of the register address bits 303 has been sent from the high frequency IC 201 to the front-end component 202.

The situation may arise that at the time of the development or the production of the high frequency IC 201 it is not yet clear in which way the bits of the write register 209 specify the operation of the front-end component 202. This may for example be the case when at the time of the production of the high frequency integrated circuit 201 it has not yet been decided the front-end component 202 of which manufacturer is to be used and the front-end components of different manufacturers use different bit assignments of the write register 209, i.e. the same bit of the write register 209 (for example bit number 0) has different meanings in the front-end components of different manufacturers. Accordingly, it may not be known what data bits 304 are to be sent from the high frequency IC 201 to the front-end component 202 for initiating a certain command or performing a certain setting of the front-end component 202 at the time of the development or production of the high frequency IC 201. Therefore, in one embodiment, the value of the data bits 304 for a certain controlling function, for example for initiating a certain command in the front-end component 202, are not fixed in the high frequency IC 201 but are configurable such that they may be correctly set according to the design of the front-end component 202.

For each controlling function and for each relevant possible design of the front-end component 202, i.e. for all front-end components that should be controllable by the high frequency IC 201, the data bits to be signalled to the front-end component 202 for performing the controlling function according to the respective design should be available.

This may done by storing, for each relevant possible design and for each controlling function, the respective data bit values in an internal memory, for example a ROM, of the high frequency IC 201 or in an external ROM coupled to the high frequency IC 201, for example in an EPROM (erasable programmable read only memory), which may be accessed by the high frequency IC 201. Alternatively another component may send the necessary data bits to the high frequency IC 201, for example the baseband IC 101 may send the necessary data bits to the high frequency IC 201 which are stored for example in a RAM (random access memory) of the mobile radio device 100. In any case, a lot of memory is necessary to store the data bits for every controlling function and every possible design of the front-end component 202.

When the data bits for a certain control function are stored in a memory, or alternatively whole data telegrams are stored in the memory, the high frequency integrated circuit reads, when it wants to control the front-end components 202 according to the control function, the data bits or the data telegram from the memory and sends it to the front-end component 202.

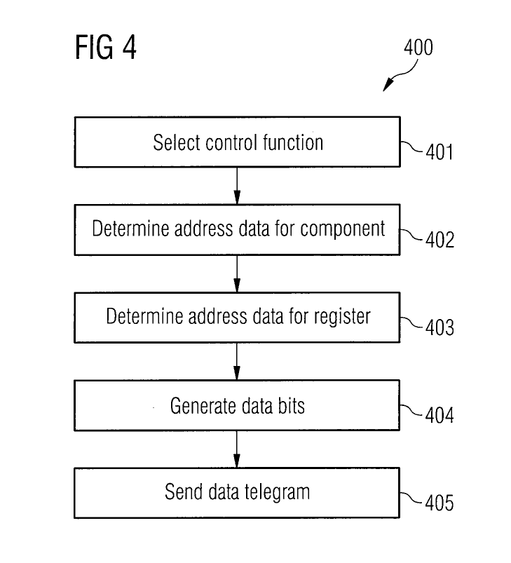

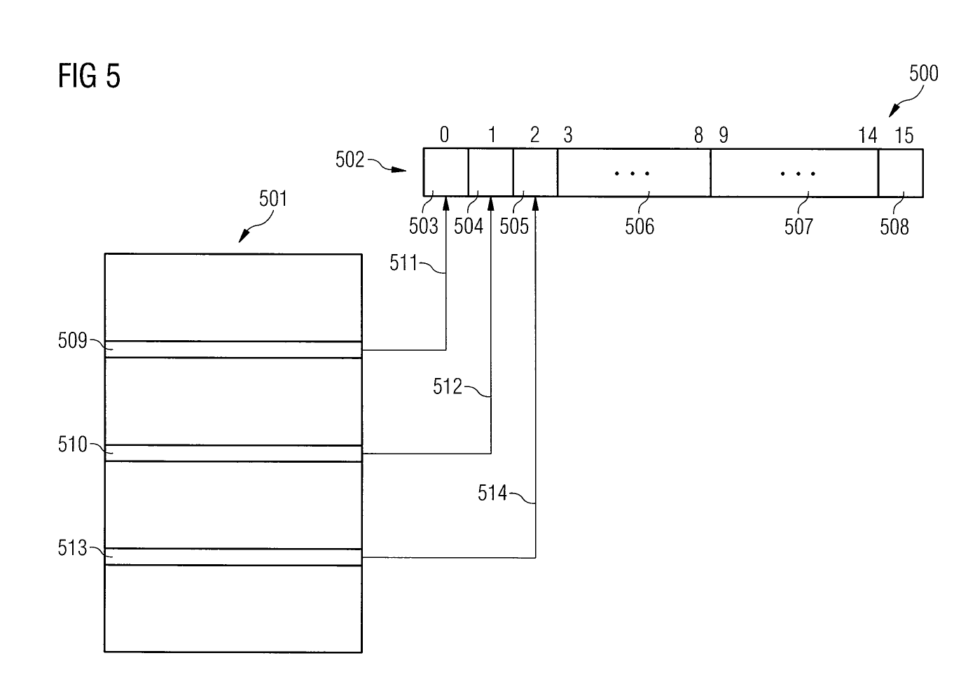

Since the memory requirements would be very high in the case that the data bits or data telegrams are stored in a memory, in the embodiment described in the following, the high frequency integrated circuit 201 generates the data telegrams according to the control function it wants to perform. This is explained in the following with reference to FIG. 4.

FIG. 4 shows a flow diagram 400 according to an embodiment of the invention.

In 401, the control function to be performed is selected by the high frequency IC 201. This may for example be done because of a corresponding command by the baseband IC 101.

For example, it is assumed that the front-end component 202 is a power amplifier which can work in GSM (global system for mobile communications) mode in which it operates according to GSM data transmission and in EDGE (enhanced data rates for GSM evolution) mode in which it operates according to EDGE data transmission. For example, the control function to be performed is to activate the power amplifier and to switch it into EDGE mode.

When the control function to be performed has been selected the high frequency IC 201 starts to generate a data telegram 300 to be sent to the front-end component 202. In 402, the high frequency IC 201 determines the device address of the front-end component 202 and sets the device address bits 302 in the data telegram 300 accordingly. The address of the front-end component 202 may for example be determined using an address table stored in a high frequency IC 201. The address table includes the device address bits for each of the front-end components 103 of the mobile radio device 100.

Similarly, in 403, the high frequency IC 201 determines the register address of the write register 209 (these address bits may be trivial if there is only one write register 209) to which the data bits 304 have to be written for the selected controlling function and sets the register address bits 303 accordingly. For example, a register address table may be stored in a high frequency IC 201 which, for each controlling function and for each relevant possible design of the front-end component 202 includes the necessary register address bits 303.

It may be provided for performing a controlling function that data bits are written to different write registers 209 of the front-end device 202. In this case, the register address bits for each write register 209 to which data bits need to be written may be stored in the register address table and a high frequency IC 201 takes into account for which write register 209 it currently generates the data bits when generating the data bits 304 and sets the register address bits according to the register for which the data bits are to generated. For simplicity, it is assumed that data bits have only to be written into one write register 209 for performing the control function. Other scenarios are possible, however, such as that the data bits are written to more than one register or to parts of one or more registers.

In 404, the high frequency IC 201 determines the data bits to be written to the write register 209 for performing the control function. This is carried out by using one or more data bit generation rules. The rules are for example stored in the form of a rule table in the high frequency IC 201. The rule table holds the data bit generation rules for each control function and for each relevant possible design of the front-end component 202.

A rule is for example that a certain data bit of the data bits 304 should be set to the value of a bit in the HFIC memory 210 at a certain position, for example at a certain position of a register of the high frequency IC 201. For example, the information that the front-end component 202 should be switched on is stored in the HFIC memory 210 at a first position of the HFIC memory 210 and for switching on the front-end component 202, this information (which is for example the bit value 1) has to be written at a second position into to the write register 209 for the control function selected and for the design of the front-end component 202 that is used in the mobile radio device 100. In this case, a rule table for example says that the value of the bit in the HFIC memory 210 at the first position should be inserted into the data bit part 304 of the data telegram 300 at the second position.

A rule may specify more than one bit stored in the HFIC memory 210 to be inserted in the data bits and may specify a memory address of the HFIC memory 210 at which bit values are stored to be inserted as data bits into the data telegram 300 at positions also specified by the rule.

In the case that the front-end component 202 includes more than one write register 209 to which data needs to be written for performing the control function, a rule may further specify the register address (for example in form of the register address bits to be inserted in the data telegram) or a register number of the write register to which data needs to be written.

A rule may further specify that a region of the HFIC memory 210 (e.g. a part of a register of the HFIC 201) should be taken and shifted by a certain amount of digits and inserted into the data telegram 300. In this way, various parts of the data bit word 304, i.e. the plurality of data bits 304, may be generated and are for example combined according to an OR operation to form the data bit word 304 to be inserted into the data telegram 300.

By using such generation rules, the memory requirement compared to the case where the data bits for each possible control function and each relevant possible design of the front-end component 202 are stored may be significantly reduced particularly in the case where the same information are combined for many cases, for example the same information stored in the HFIC memory 210 is used for a multiplicity of designs of the front-end component 202 but has to be inserted at different positions in the data telegram 300. Note that the rules may not only be stored for every control function and every design of the front-end component but also for other types of front-end components such that the high frequency IC 201 may generate data telegrams 300 for controlling various types of front-end components 202.

The same information may be used by different types of front-end components 202. For example, the information stored in the high frequency IC 201 that the mobile radio device is in sending mode may be used in a power amplifier and an antenna switch.

In 405, when the high frequency IC 201 has generated the data bits 304 it sends the data telegram 300 to the front-end component 202 as explained above.

In addition to a generation rule specifying that data should be read at a specified position in a memory of the high frequency IC 201 and should be inserted (shifted or copied) into the data telegram 300 at a specified position, there may be generation rules for the case that information stored in the HFIC 201 is not inserted into the data telegram 300 one to one but is combined with other information stored in the HFIC 201. It may also be the case that information to be written into the write register 209 is stored in the HFIC 201 using more bits than are designated for storing the information in the write register 209.

For example, in the HFIC 201 the information may be stored which one of eight paths of an antenna switch is to be activated in the form of eight bits, wherein each bit of the eight bits corresponds to an antenna path and only one of the bits at a time is set to one and the corresponding antenna path is to be activated. However, for this information, in the corresponding antenna switch only three bits could be provided wherein each of the eight possible bit combinations of the three bits corresponds to a data path to be activated. These three bits have to be written by the high frequency IC into the write register of the antenna switch and the corresponding rule would specify how the eight bits stored in the HFIC 201 have to be transformed to the three bits.

This may for example be implemented using two rule tables, wherein the first rule table holds a rule specifying that an information stored at a first position of the HFIC memory 210 has to be inserted into the data telegram at a second position and, if applicable, an indication specifying that the information stored in the HFIC 201 is to be converted (like the eight bits into the three bits in the above example). The second rule table holds a rule specifying how the information is to be converted before it is inserted at the second position into the data telegram 300 (for example the rule how the eight bits are to be converted into the three bits in the above example). The second rule may be stored in the second rule table at a position which is indicated in the first rule table. Since for a multiplicity of designs and types of front-end components rules to convert information will be similar, the memory requirement of the second rule table typically will be low.

In the above, it was assumed that data bits should be sent from the HFIC 201 to the front-end components 201. However, as explained above with reference to FIG. 3, data may also be read from the front-end component 202. This may happen analogously to the generation of the data bits according to rules.

In this case, the rules for example specify a first location in the read register 208 and a second location in the HFIC 201 where this information is to be stored. The information is then extracted from the data bits from the first position since in the reading case, the data bits 304 are the content of the read register 208 as explained above and the information is stored in the HFIC memory at the second position.

As is in the write case, further rules may be used to convert the information. As in the example in which the front-end component 202 is an antenna switch, the three bits may for example be converted to eight bits before they are stored in the HFIC memory 210. Data read by the HFIC 201 may for example be sensor data (for example the data of a temperature sensor of a power amplifier) which is to be processed by the HFIC 201.

The rule table or the rules tables are for example stored in the HFIC 201 when the mobile radio device 100 is turned on. For example, the rule table or rule tables are sent by the baseband IC 101 to the HFIC 102 when the mobile radio device 100 is switched on and are stored in volatile memory of the HFIC 102 and are used during run time to generate the data telegrams to control the front-end components 103.

The rules for generating the data bits according to a control function may be stored in more general form as commands of a construction programming language. In this case, the commands are stored in the HFIC 201 and are carried out using a parser such that the data bits are generated accordingly.

In the following, an example for the generation of a telegram to be sent from the HFIC 201 to the front-end components 202 is explained with reference to FIG. 5.

FIG. 5 shows a data flow diagram 500 according to an embodiment of the invention.

Data is inserted from a memory 501 of the HFIC 201 into the data bit field 502 of a data telegram 300. The data bit field 502 is to be written one to one into the write register of the front-end component 202 which is in this case assumed to be a power amplifier.

The bits of the data word field are assumed to be numbered from 0 to 15.

Bit 0 is an activation bit 503 and specifies the activation status of the power amplifier. A value 0 of bit 0 indicates that the power amplifier is to be switched off and a value 1 of bit 0 indicates that the power amplifier is to be switched on.

Bit 1 is a mode bit 504 indicating the mode in which the power amplifier should be in. The value 0 of bit 1 indicates that the power amplifier should be in GSM mode and the value 1 of bit 1 indicates the power amplifier should be in EDGE mode.

Bit 2 is a band bit 505 indicating according to which of two frequency bands the power amplifier should be operating. A value 0 of bit 2 indicates that the power amplifier should be operating according to a high band and a value 1 of bit 2 indicates that the power amplifier should be indicating according to a low band.

Bits 3 to 8 are sensor bits 506 assumed to be indicating a configuration of a sensor of the power amplifier.

Bits 9 to 14 are reserved bits 507 which are not assigned a functionality.

Bit 15 is a special functionality bit 508 indicating whether a special functionality (for example a certain bus note) is to be activated (value 1 of bit 15) or deactivated (value 0 of bit 15).

For the following example, it is assumed that the power amplifier should be controlled such that it is switched on, operates according to high band and is in EDGE mode.

The high frequency IC 201 looks up in a rule table the rule according to which the data bits should be generated for the case that the power amplifier is to be switched on. In this example, the rule specifies that the information stored in the memory 501 at a first position 509 (which holds the information whether the power amplifier should be switched on or should be switched off) is to be inserted into the data bits at position bit 0 which is indicated by a first arrow 511 in FIG. 5.

Analogously, the mode information at a second position 510 in the memory 501 is inserted at bit 1 according to a corresponding rule. This is indicated by a second arrow 512. Furthermore, the band information stored at a third position 513 in the memory 501 is stored at bit 2 in the data bit word 502 as indicated by a third arrow 514. The remaining bits are in this example by default set to the value 0 (bit 3 to 15).

When the rules for the control function to switch on the power amplifier in EDGE mode according to high band operation have been processed the generation of the data bit word 502 is finished and the data telegram including the data bit word 502 may be transmitted to the power amplifier.

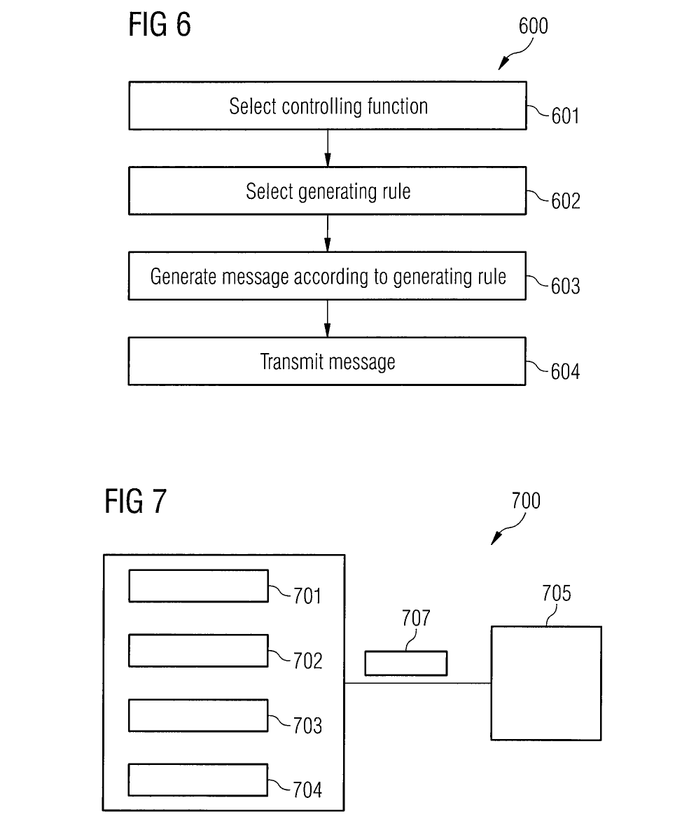

In the following, examples for embodiments of the invention are described with reference to FIGS. 6 and 7.

FIG. 6 shows a flow diagram 600 according to an embodiment of the invention.

The flow diagram 600 illustrates the flow of a method for controlling an electronic circuit.

In 601, a controlling function is selected to control the electronic circuit.

In 602, at least one pre-stored generating rule is selected from a plurality of pre-stored generating rules according to which a message which is to be transmitted to the electronic circuit for carrying out the controlling function is to be generated

In 603, the message is generated according to the at least one selected generating rule.

In 604, the message is transmitted to the electronic circuit.

FIG. 7 shows a controlling circuit 700 according to an embodiment of the invention.

The controlling circuit 700 includes a first selecting circuit 701 selecting a controlling function to control an electronic circuit 705.

Further, the controlling circuit 700 includes a second selecting circuit 702 selecting at least one pre-stored generating rule from a plurality of pre-stored generating rules according to which a message 707 which is to be transmitted to the electronic circuit 706 for carrying out the controlling function is to be generated.

A generating circuit 703 of the controlling circuit 700 generates the message 707 according to the at least one selected generating rule and a transmitting circuit 704 transmits the message 707 to the electronic circuit 706.

In addition to being applied in mobile radio devices, embodiments of the invention may also be used in other systems where an electronic circuit is controlled. For example, embodiments of the invention may be used in automobiles for the controlling of electronic circuits that are part of the automobile's electronic controlling system. For instance, messages to control an electronic circuit that controls valves of an engine may be generated by a controlling circuit in a car.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for controlling an electronic circuit, comprising:
selecting a controlling function to control the electronic circuit;
selecting at least one pre-stored generating rule from a plurality of pre-stored generating rules according to which a message which is to be transmitted to the electronic circuit for carrying out the controlling function is to be generated;
generating the message according to the at least one selected generating rule; and
transmitting the message to the electronic circuit.

2. The method according to claim 1, wherein the message comprises a data word and the at least one pre-stored generating rule specifies first positions of a memory at which bits are read from the memory and second positions in the data word at which the bits read are written into the data word.

3. The method according to claim 2, wherein the at least one rule further specifies at least one combination operation according to which the bits read are combined, and
the method further comprises writing the combined bits into the data word.

4. The method according to claim 1, wherein the pre-stored generating rule is selected based on the type of the electronic circuit.

5. The method according to claim 1, wherein the pre-stored generating rule is selected based on the type of the controlling function.

6. The method according to claim 1, wherein the plurality of pre-stored generating rules comprises a generating rule for a plurality of pairs of a type of the electronic circuit and a type of the controlling function.

7. The method according to claim 1, wherein the electronic circuit is controlled by another electronic circuit, and the electronic circuit and the other electronic circuit are part of the same computer.

8. The method according to claim 1, wherein the electronic circuit and the other electronic circuit are located in the same housing.

9. The method according to claim 1, wherein the electronic circuit and the other electronic circuit are coupled by an interface and the message is transmitted via the interface.

10. The method according to claim 9, wherein the interface is a parallel or a serial interface.

11. The method according to claim 10, wherein the interface is a bus.

12. The method according to claim 1, wherein the electronic circuit is an electronic circuit of a mobile communication device.

13. The method according to claim 12, wherein the electronic circuit is a front-end component of the mobile communication device.

14. The method according to claim 12, wherein the electronic circuit is controlled by another electronic circuit of the mobile communication device.

15. The method according to claim 14, wherein the other electronic circuit is a high frequency integrated circuit.

16. The method according to claim 1, wherein the controlling function switches the electronic circuit on or off, switches the electronic component into one of a plurality of modes, activates or deactivates a function of the electronic circuit, or sets the physical parameters for the operation of the electronic circuit.

17. A controlling circuit comprising:
a first selecting circuit configured to select a controlling function to control an electronic circuit;
a second selecting circuit configured to select at least one pre-stored generating rule from a plurality of pre-stored generating rules according to which a message which is to be transmitted to the electronic circuit for carrying out the controlling function is to be generated;
a generating circuit configured to generate the message according to the at least one selected generating rule; and
a transmitting circuit configured to transmit the message to the electronic circuit.

18. A computer program product, which, when executed by a computer, makes the computer perform a method for controlling an electronic circuit, the method comprising:
selecting a controlling function to control the electronic circuit;
selecting at least one pre-stored generating rule from a plurality of pre-stored generating rules according to which a message which is to be transmitted to the electronic circuit for carrying out the controlling function is to be generated;
generating the message according to the at least one selected generating rule; and
transmitting the message to the electronic circuit.

19. A method for controlling an electronic circuit comprising:
selecting at least one pre-stored generating rule from a plurality of pre-stored generating rules according to which a message which is to be transmitted to the electronic circuit for carrying out a controlling function to control the electronic circuit is to be generated; and
generating the message according to the at least one selected generating rule.

20. The method according to claim 19, wherein the message comprises a data word and the at least one pre-stored generating rule specifies first positions of a memory at which bits are read from the memory and second positions in the data word at which the bits read are written into the data word.

21. The method according to claim 20, wherein the at least one rule further specifies at least one combination operation according to which the bits read are combined, and
the method further comprises writing the combined bits into the data word.

22. The method according to claim 19, wherein the pre-stored generating rule is selected based on the type of the electronic circuit.

23. A controlling circuit comprising:
a first selecting means for selecting a controlling function to control an electronic circuit;
a second selecting means for selecting at least one pre-stored generating rule from a plurality of pre-stored generating rules according to which a message which is to be transmitted to the electronic circuit for carrying out the controlling function is to be generated;
a generating means for generating the message according to the at least one selected generating rule; and
a transmitting means for transmitting the message to the electronic circuit.

24. A computer program product, which, when executed by a computer, makes the computer perform a method for controlling an electronic circuit, the method comprising:
selecting at least one pre-stored generating rule from a plurality of pre-stored generating rules according to which a message which is to be transmitted to the electronic circuit for carrying out a controlling function to control the electronic circuit is to be generated; and
generating the message according to the at least one selected generating rule.
